(19) United States
(12) Patent Application Publication
(10) Pub. No.: US 2003/0084722 A1
(43) Pub. Date: May 8, 2003

(54) Vibration-type micro-gyroscope

(76) Inventors: Yong-kweon Kim, Seoul (KR); Hyung-Taek Lim, Seoul (KR); Jae-Wook Rhim, Daejon (KR)

Correspondence Address: Scully Scott, Murhpy & Presser, 400 Garden City Plaza, Garden City, NY, 11530, US

(21) Appl. No.: 10/182,214

(22) PCT Filed: Jan. 22, 2001
(86) PCT No.: PCT/KR01/00109

(30) Foreign Application Priority Data
Jan. 27, 2000 (KR) 20004090
Jun. 20, 2000 (KR) 200033928

(51) Int. Cl. G01P 15/08

(52) U.S. Cl. 73/504.08; 73/504.12

(57) ABSTRACT

The present invention is for a vibration-type micro-gyroscope. The micro-gyroscope according to the present invention has an inner driving gimble and an outer detecting gimble. The inner gimble is driven by electrostatic force and the outer gimble detects variance of capacitance induced by angular velocity. The outer gimble is connected to a fixing axis through a first plate-spring and the inner gimble is connected to the outer gimble through a second plate-spring.

### BACKGROUND OF THE INVENTION

(a) Field of the Invention

The present invention relates to a vibratory micromachined gyroscope, and more particularly, to a vibratory micromachined gyroscope with a planar gimbals structure.

(b) Description of the Related Art

For many years, an angular rate sensor for detecting an angular rate of an inertial body has been used as a core part of navigation instruments for missiles, motor vessels, aircraft, satellites, etc., and the application field for such sensors is now expanding from military to civil use, such as for automobile driving instruments or a compensator for detecting and correcting the trembling of highly-amplified hand-held video cameras.

Generally, the principle of the angular rate sensor, that is, a gyroscope is to detect an angular rate of an inertial body vibrating or rotating about one axis (referred to as “first axis”) by detecting Coriolis' force that is generated toward another axis perpendicular to the first axis when the inertial body receives input of an angular rate from a third direction perpendicular to the above two directions. At this time, the detection accuracy of the angular rate can be improved by balancing the force applied on the inertial body. It is preferable to use a force balance method particularly for increasing the linearity and bandwidth of signals.

Previously, however, such vibratory micromachined gyroscope were structured with a system causing a mechanical interference between a drive part and a sensor part. The mechanical interference in driving and detecting causes a large error of the degrees of angular rate signals, a negative effect on the gyroscope driving, a significant floating measurement error and a difficulty in arranging the locations of the drive and sensor modes.

More recently, vibratory micromachined gyroscopes have been fabricated with a mechanically separated gimbals structure. The gimbals-structured vibratory gyroscope can significantly reduce the above errors owing to its structure of two mechanically-separated resonant modes, but the amount of space the gimbals structure occupies in a sensing part of the gyroscope is too large because of the structural design of the sensor, thereby requiring an increase of the sensor size. However, the sensor size cannot be arbitrarily increased in order to facilitate a good sensitivity of the sensor because of inner residual stress on a structural layer. That is, procedural or technological constraints in manufacturing the sensors may be considerable such as difficulty in employing a surface micromachining process and instead, having to employ Silicon On Insulator (SOI) or Si bulk machining technology.

In addition to the sensitivity issue as above, its size, etc. should be robust enough to endure the power of the mechanical responses and disturbances from the outside, which results in decreasing its quality factor (Q) in the dynamic response of the sensor, and therefore decreases the functional performance thereof.

### SUMMARY OF THE INVENTION

To solve the problems described above, it is an object of the present invention to provide an angular rate sensor with a planar gimbals structure, operated by way of electrostatic drive and capacitance variation detection.

Another object of the present invention is to provide an angular rate sensor with electronic and mechanical responses connected for improving the performance of a micromachined gyroscope.

To achieve the above object, a vibratory micromachined gyroscope according to one aspect of the present invention comprises an inner drive gimbals of a planar structure and an outer sensor gimbals of a planar gimbals structure, and it is operated by way of electrostatic drive and capacitance variation detection.

Further, the vibratory micromachined gyroscope according to another aspect of the present invention may comprise a drive gimbals for vibrating a whole gimbals structure in a first direction, a sensor gimbals moving in a second direction perpendicular to the first direction when an angular rate is applied, a driven mode flexure connecting the drive gimbals with a fixed anchor and moving in the first direction, and a sensor mode flexure connecting the drive gimbals and the sensor gimbals and moving in the second direction.

Objects and advantages of the present invention will be set forth in the description which follows, and in part will be obvious from the description, or may be learned by practice of the invention. The objects and advantages of the invention may be realized by means of the combinations particularly pointed out in the claims.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a perspective view of a micromachined gyroscope according to one embodiment of the present invention;

FIG. 2 is a plane view of the micromachined gyroscope of FIG. 1:

FIG. 3 illustrates the operational principles of the micromachined gyroscope according to the present invention

FIG. 4 is a perspective view of mode flexures 3, 4 of the micromachined gyroscope of the FIG. 1;

FIG. 5a is a perspective view of a parallel plate capacitor;

FIG. 5b is a perspective view of a transverse comb capacitor employed on one embodiment of the present invention;

FIG. 6 is a circuit diagram showing one embodiment of the present invention using gyroscope capacitance;

FIG. 7a is a circuit diagram showing the angular rate measurement process according to one embodiment of the present invention;

FIG. 7b shows graphical representations of output processes of angular rates through the circuits of FIG. 7a;

FIG. 8 shows output wave forms of the gyroscope according to one embodiment of the present invention; and

FIG. 9 is a graphical representation showing voltage outputs for applied angular rates on the gyroscope according to one embodiment of the present invention.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature and not restrictive.

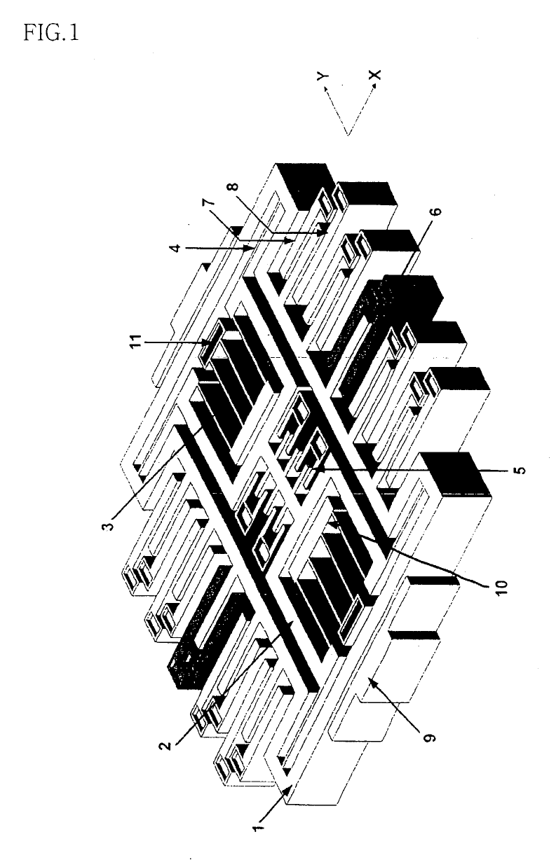

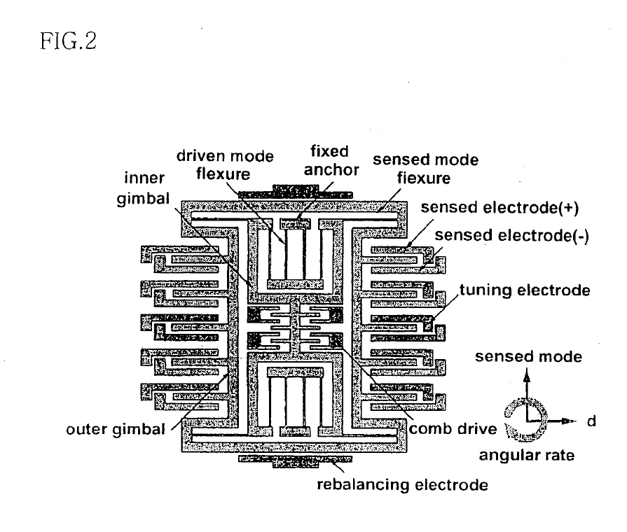

FIG. 1 is a perspective view of a micromachined gyroscope according to one embodiment of the present invention, and FIG. 2 is a plane view of the micromachined gyroscope of FIG. 1.

A micromachined gyroscope of the present invention comprises an outer sensor gimbals 1, an inner drive gimbals 2, a fixed anchor 11 of the gimbals, a driven mode flexure 3 for connecting the inner drive gimbals 2 and the fixed anchor 11, a sensor mode flexure 4 for detecting the inner drive gimbals 2 and the outer sensor gimbals 1, a drive electrode 5 for causing vibration of the gimbals, positive (+) and negative (−) sensor electrodes 7,8 for detecting the displacement variation of the outer sensor gimbals 1 according to applied angular rates, a tuning electrode 6 for controlling the second-directional displacement of the outer sensor gimbals 1 according to the angular rate, and a rebalancing electrode 9 for repressing the vibration of the outer sensor gimbals 1.

The inner drive gimbals 2 comprises C-shaped frames placed on both sides thereof with a comb-shaped part at its center connecting the C-shaped frames and intermeshed with the comb-shaped drive electrodes 5.

The inner drive gimbals 2 also comprises a driven mode flexure 3 extending in the Y-axis direction inside the C-shaped frames and being movable in the X-axis direction, and a buffer 10 located between the inner drive gimbals 2 and the fixed anchor 11 for alleviating the axial directional force (Y-axis) on the flexure 3, and making a large drive displacement possible.

The driven mode flexure 3 connects the inner drive gimbals 2 and the buffer 10 and then, connects the buffer 10 and the fixed anchor 11. The outer sensor gimbals 1 comprises an H-shaped frame surrounding the inner drive gimbals 2, and a sensor comb outwardly extending from the frame. The outer sensor gimbals 1 is connected with the inner drive gimbals 2 by a sensor mode flexure 4 movable in the Y-axis direction.

The positive sensor electrodes 7 and the negative sensor electrodes 8 are arranged equidistant from and parallel to each side of each comb tooth of the outer sensor gimbals 1, and the tuning electrode 6 with a same shape >as the sensor electrodes 7, 8 is provided. The number of sensor electrodes 7, 8, tuning electrode 6 and drive electrode 5 can be changed as necessary. Rebalancing electrodes 9 are provided on both ends of the frame of the outer sensor gimbals 1. The gimbals 1, 2 are suspended by the fixed anchor 11 so they are movable.

A flexure structure folded from the end of the inner drive gimbals 2 (connected to the buffer 10) is rigid enough to endure rotational outer disturbances in the Z-axis direction. In addition, the above gimbals structure can be rigid enough to withstand the application of accelerated rates of force in the Z-axis direction if the thickness of the structure is above a certain limit. The outer sensor gimbals 1, the closed H-shape curve, is also mechanically very rigid.

The tuning electrodes 6 are placed on both sides of the sensor comb tooth that is a part of the sensor comb of the outer sensor gimbals 1 and they control the Y-axis directional displacement of the outer sensor gimbals 1 to expand the range of measurable accelerated rates. That is, even when a large accelerated rate is manifested, the tuning electrode 6 can restrain the displacement of the outer sensor gimbals 1 thereby increasing the ratio of the accelerated rate to the outer sensor gimbals displacement.

The rebalancing electrode 9 helps to improve the accuracy for the continuous measurement of the accelerated rate by quickly stopping the Y-axis directional vibration of the outer sensor gimbals 1.

Generally, good sensitivity of a micromachined gyroscope requires a large drive displacement and a large variation of capacitance. In particular, a micro electromechanical system (MEMS) drive part requires a relatively large drive displacement for its flexure size so that it shows non-linearity in its drive displacement characteristics. Distortion of micromachined gyroscope linear momentum, and deformation of output signals is caused by the axial directional force on the flexure. Therefore, the present invention employs a folded flexure structure in order to alleviate the force and obtain a large drive displacement, and it is designed such that a drive displacement is 45 μm at maximum, and the capacitances of the flexure of drive elements, gimbals structure, and sensor elements are maximized. FIG. 1 shows the micromachined gyroscope structured as above.

As stated, the micromachined gyroscope of the present invention can obtain a large drive displacement and a large capacitance of 3.655 pF with its sensing structure size of 1.1×1 mm² and by its structural design having the drive gimbals placed inside and the sensor gimbals placed outside. Furthermore, the micromachined gyroscope of the present invention reduces parasitic and floating capacitance and prevents performance deterioration of the sensor functions because of the structural displacement of the drive and sensor part as above.

The planar gimbals structured micromachined gyroscope according to the present invention does not show a decrease in its functional performance even with processing errors, and it provides a high degree of sensitivity because of its high quality factor (Q), and operational characteristic in a vacuum environment.

The micromachined gyroscope of the present invention is made to have an electrical-mechanical response sensitivity of 1.828 pF/μm, which corresponds to either several or dozens of times that of the conventional micromachined gyroscope.

In addition, resonant frequencies of the drive and sensor parts deviate by roughly 2% and therefore a good sensitivity is maintained and band-width is expanded.

A detailed description of the driving principle of the micromachined gyroscope structured as above will now be provided.

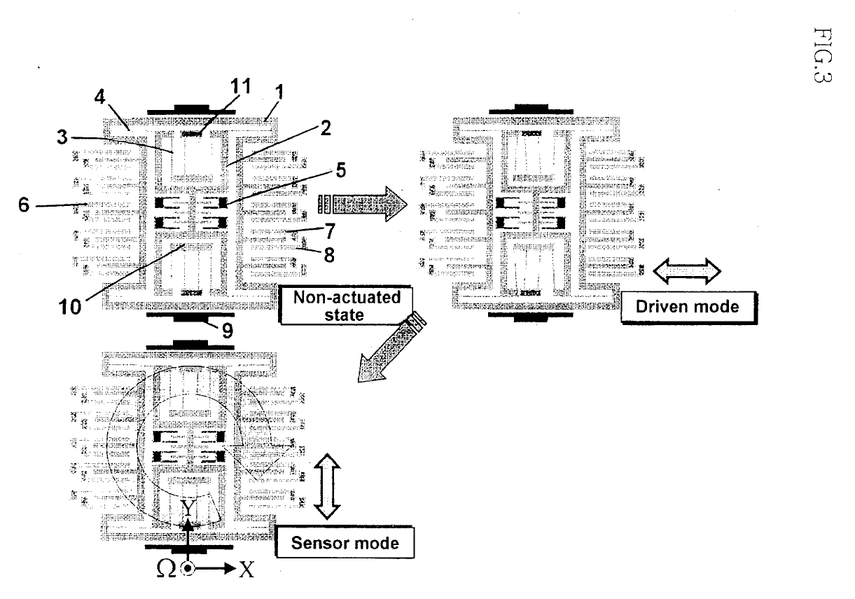

FIG. 3 illustrates the driving principle of the micromachined gyroscope according to one embodiment of the present invention.

The gimbals 1, 2 are vibrated in the X-axis direction when a specific frequency of voltage is applied to the drive electrode 5 (drive mode). The drive electrode 5 applies impulses to the drive comb of the inner drive gimbals 2, but the outer sensor gimbals 1 also vibrates because the sensor mode flexure 4 is not movable in the X-axis direction.

While the gimbals 1, 2 are vibrating, the outer sensor gimbals 1 moves in the Y-axis direction because of the Coriolis effect when an angular rate (Ω) owing to a rotation movement is applied. That is expressed as the vector product,

y∝Ω×x.

Since the driven mode flexure 3 has no movement in the Y-axis direction, the inner drive gimbals 2 does not incur a displacement in the Y-axis direction. As above, when the gimbals 1, 2 are driven (X-axis direction), the outer sensor gimbals 1 vibrates in the direction perpendicular to the above drive direction of the gimbals 1, 2 (Y-axis direction). Since the inner drive gimbals 2 and the outer sensor gimbals 1 are connected to each other by the planar mode flexure structure, which is rigid in the above drive direction, no interference occurs between them with respect to the displacement response of the drive and the sensor.

In the case the outer sensor gimbals 1 moves in the Y-axis direction, the distance between the sensor comb and the sensor electrodes 7, 8 is changed, and a first capacitance between the positive sensor electrode 7 and the sensor comb is increased while a second capacitance between the negative sensor electrode 8 and the sensor comb is decreased. On the contrary, if the displacement direction of the outer sensor gimbals 1 is in the opposite direction, the changes of the capacitances are opposite. By the detection of the capacitance variation, the corresponding angular rate can be determined.

The micromachined gyroscope of the present invention is characterized in that the drive electrode 5, the sensor electrodes 7,8, the inner drive gimbals 2, the outer sensor gimbals 1, and the sensor mode flexures 3,4 are all evenly placed on one plane and are of the same material and height, and it is a one layered-structure.

As above, the planar vibratory gyroscope of the present invention is advantageous in that the resonant frequency can be selected accurately during the structure fabrication because the resonant frequency is independent from its height, and the ratio of the resonant frequencies of the driven mode flexure 3 (drive part) and the sensor mode flexure 4 (sensor part) is constant even with thickness errors of the mode flexures 3,4.

Now, the above advantages are mathematically proven.

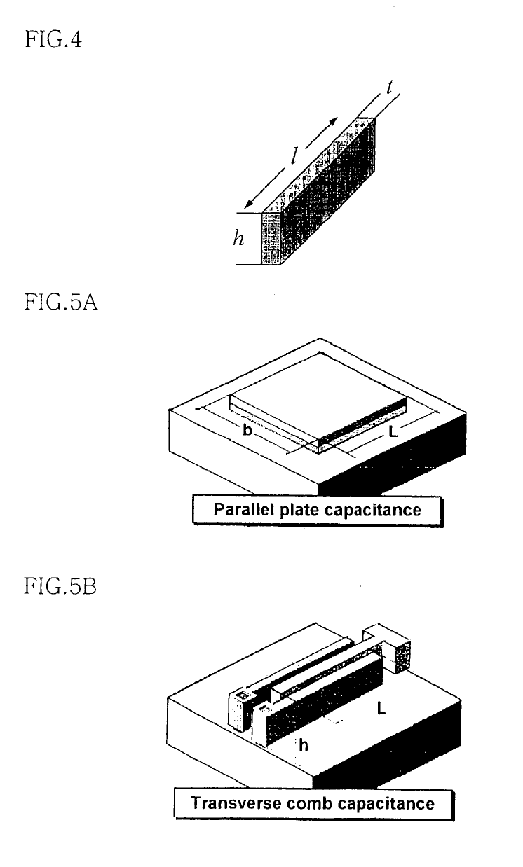

FIG. 4 is a perspective view of mode flexures 3, 4 of the micromachined gyroscope of FIG. 1.

The mode flexures 3, 4 are cubical, with height, length and thickness given as h, l and t respectively. Other design variables are shown in Table 1.

TABLE 1

| factor | design variable |
|---|---|
| Young's modulus | E |
| drive part | |
| length | lₖₓ |
| thickness | tₖₓ |
| height | hₖₓ |
| sensor part | |
| length | l_{ky} |
| thickness | t_{ky} |
| height | h_{ky} |
| height | h |

The flexure constant of the driven mode flexure 3 is determined below. Here, kₓₒ is a flexure constant of one part of the driven mode flexure 3, and kₓ is a flexure constant over the entire driven mode flexure 3.

kₓₒ=Eh(tₖₓ/lₖₓ)³

kₓ=2kₓₒ

The flexure constant of the sensor mode flexure 4 is determined below. Here, k_{yo} is a flexure constant of one part of the sensor mode flexure 4, and k_{y} is a flexure constant over the entire sensor mode flexure 4.

k_{yo}=Eh(t_{ky}/l_{ky})³

k_{y}=4k_{yo}

Now, resonant frequencies are calculated. Other design variables for calculating the resonant frequency are shown in Table 2.

TABLE 2

| factor | design variable |
|---|---|
| mass density | |
| drive part | |
| mass of drive part | Mₓ |
| resonant frequency | ωₓ₀ |
| inner gimbals space | S_{d} |
| sensor part | |
| mass of sensor part | M_{y} |
| resonant frequency | ω_{y0} |
| outer gimbals space | Sₛ |
| height | h |

The drive mass for driving the micromachined gyroscope according to the present invention will be given by combining the masses of the inner drive gimbals 2 and the outer sensor gimbals 1 and then,

Mₓ=ph(S_{d}+Sₛ)

The sense mass is the mass of the outer sensor gimbals 1 only and is expressed as

M_{y}=phSₛ

Therefore, the resonant frequencies of the drive part and the sensor part will be given by

ωₓₒ=\sqrt{kₓ/Mₓ}

$$\begin{matrix}{ω}_{xo} = \sqrt{{k}_{x} / {M}_{x}} \\ = \sqrt{\frac{2 {Eh ( {t}_{kx} / {l}_{x} )}^{3}}{ρ h ( {S}_{d} + {S}_{s} )}}\end{matrix}$$

ω_{yo}=\sqrt{k_{y}/M_{y}}

$$\begin{matrix}{ω}_{yo} = \sqrt{{k}_{y} / {M}_{y}} \\ = \sqrt{\frac{4 {Eh ( {t}_{ky} / {l}_{y} )}^{3}}{ρ {hS}_{s}}}\end{matrix}$$

Generally, in the fabrication process of the micromachined gyroscope, feature deformation often occurs by various fabrication processing errors. Among the various processing errors, we consider the effect of a height (h) error on the resonant frequencies of the gyroscope below. The sensitivity of the resonant frequency for the height will be obtained by partially differentiating the resonant frequency with height.

$$\begin{matrix}\frac{\partial {ω}_{x0}}{\partial h} = \frac{\partial }{\partial h} ( \sqrt{\frac{2 {Eh ( {t}_{kx} / {l}_{kx} )}^{3}}{ρ h ( {S}_{d} + {S}_{s} )}} = 0 \\ \frac{\partial {ω}_{y0}}{\partial h} = \frac{\partial }{\partial h} ( \sqrt{\frac{4 {Eh ( {t}_{ky} / {l}_{ky} )}^{3}}{ρ {hS}_{s}}} = 0\end{matrix}$$

As shown from the above equations, the resonant frequency of the planar vibratory gyroscope is not impacted by height (h).

Among the variables, a processing error significantly affecting the resonant frequency is the one for a thickness (t) of a flexure along with the height (h) error, which can be seen from the fact that the cube of “t”, the thickness of the flexure, is found in the resonant frequency equation as above. The variation of the resonant frequency according to the changes of the flexure thickness (t) will lead to

$$\begin{matrix}\frac{\partial {ω}_{x0}}{\partial {t}_{kx}} = \frac{\partial }{\partial {t}_{kx}} ( \sqrt{\frac{2 {Eh ( {t}_{kx} / {l}_{kx} )}^{3}}{ρ h ( {S}_{d} + {S}_{s} )}} = \frac{3 {ω}_{x0}}{2 {t}_{kx}} \\ \frac{\partial {ω}_{y0}}{\partial {t}_{ky}} = \frac{\partial }{\partial {t}_{ky}} ( \sqrt{\frac{4 {Eh ( {t}_{ky} / {l}_{ky} )}^{3}}{ρ {hS}_{s}}} = \frac{3 {ω}_{y0}}{2 {t}_{ky}}\end{matrix}$$

An important factor to be considered in the fabrication process of micromachined gyroscope is the ratio of the resonant frequency of the drive part to the resonant frequency of the sensor part because the two factors contribute to determining the sensitivity and the bandwidth of the gyroscope. As shown in the above equation, however, the resonant frequency may vary in the actual process because of the generation of processing errors, but the resonant frequency of the gyroscope of the present invention is not affected by a deviation of height (h) caused by processing errors because the gyroscope has a planar vibration structure.

With respect to the elastic factors of the gyroscope, the thickness (t) is very thin for the length (l), which is why the fabricated structure is seriously affected by processing errors. However, in the planar vibratory gyroscope of the present invention having a frame structure, the effect of the processing errors can be eliminated by making the flexure thickness (t) of the drive part and the sensor part the same, and by controlling the length (l) to select the resonant frequency values thereby maintaining the ratio of the two resonant frequencies constant. This is shown by following equations,

$$\frac{\partial {ω}_{x0}}{\partial {t}_{kx}} = \frac{{ω}_{x0} {t}_{ky}}{{ω}_{y0} {t}_{kx}} = \frac{{ω}_{x0}}{{ω}_{y0}} , ( {t}_{ky} = {t}_{kx} = t )$$

$$\frac{\partial }{\partial t} ( \frac{{ω}_{x0}}{{ω}_{y0}} ) = ( \frac{\sqrt{\frac{2 {Eh ( t / {l}_{kx} )}^{3}}{ρ h ( {S}_{d} + {S}_{s} )}}}{\sqrt{\frac{4 {Eh ( t / {l}_{ky} )}^{3}}{ρ {hS}_{s}}}} ) = 0$$

That is, the variations of the two resonant frequencies according to the thickness (t) errors are the same so that the ratios of the two resonant frequencies varied for the thickness (t) errors are also maintained constant.

FIG. 5a is a perspective view of a parallel plate capacitor, and FIG. 5b is a perspective view of a transverse comb capacitor employed in one embodiment of the present invention.

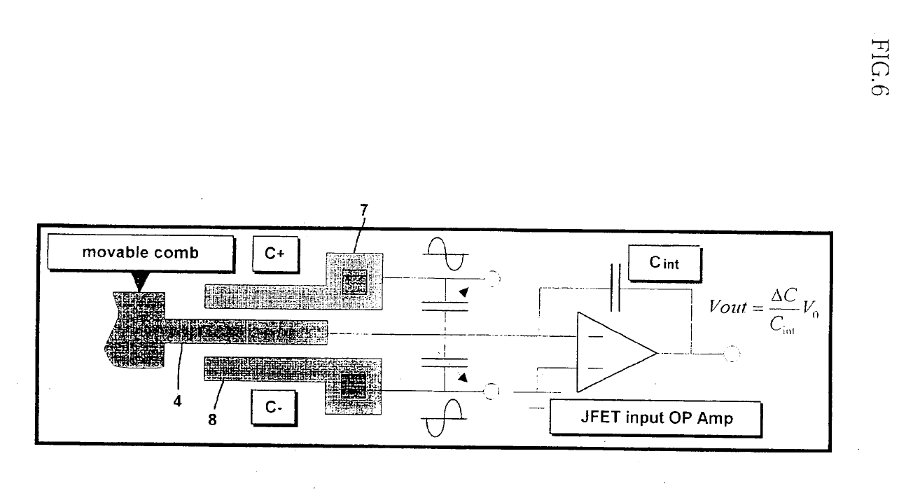

The micromachined gyroscope according to the present invention is operated in a manner such that the outer sensor gimbals 1 causes displacements by Coriolis' force by means of vibration of a driving force and the application of outer accelerated rates, and a minor displacement can be detected by variations of the capacitances between the outer sensor gimbals 1 and the sensor electrodes 7,8. The structures for sensing the displacement by means of the detection of the capacitance variation in the present invention include a parallel capacitance sensor structure and a transverse comb capacitance sensor structure as shown in FIGS. 5 and 6.

Of the two structures, a transverse comb capacitance sensor structure can develop a larger capacitance than a parallel capacitance sensor structure if the structure is properly designed and the height of the structure is increased.

The capacitance of the parallel plate electrode is given by

$${C}_{p} = {ϵ}_{0} \frac{bL}{g} ,$$

wherein g is the gap between two plates.

In addition, the capacitance of the transverse comb electrodes is given by

$${C}_{t} = {ϵ}_{0} \frac{2 hL}{g} ,$$

wherein g is the gap between electrodes.

Here, the capacitances of the electrodes per area on the substrates in the two cases can be compared. First, it is assumed that the thickness (t) of the electrode is 5 μm and the gap (g) is 2 μm in the transverse comb case. The area of the two capacitors on the substrates are given by

S(Cₚ)=L×b

S(Cₜ)=L×(5 μm+2 μm+5 μm+2 μm+5 μm+2 μm)

At this time, if two areas are equal, b=21 μm and the ratio of the two capacitances is given by

$$\frac{{C}_{t}}{{C}_{p}} = \frac{{ϵ}_{0} \frac{2 hL}{g}}{{ϵ}_{0} \frac{21 µm \times L}{g}} = \frac{h}{10.5 µm}$$

That is, if the thickness is made to be above 10.5 μm, the capacitance of the transverse comb structure per area is greater than that of the parallel structure, and the sensitivity of the gyroscope is hence improved and the structure size can be reduced so that the structure is more mechanically rigid. In addition, the transverse comb electrode structure can provide a greater capacitance than theoretically expected because additional capacitance due to a fringe field is developed, which can amount to an additional 10˜40%. In the embodiment of the present invention, the thickness is 10.3 μm.

The principle for detecting the displacement of the outer sensor gimbals with the changes of capacitance in the micromachined gyroscope according to one embodiment of the present invention will now be described.

When the outer sensor gimbals 4 moves, the gap between the sensor comb (referred to as “comb electrode”) and the sensor electrode 7, 8 is varied, and the gap variation varies the capacitance between the comb electrode and the pair of the sensor electrodes. The variation of the capacitance is detected through a connection with outer circuits. In addition, a parasitic and floating capacitance is decreased, and large sensor capacitance is obtained by installing a plurality of the comb electrode and the sensor electrodes 7,8 in the present invention. Further, the densely arranged installment of comb electrode and sensor electrodes 7,8 provides a larger capacitance than a theoretically expected, by a fringe field on the electrode sectional edges.

The capacitance detecting sensor also has advantageous characteristics such as insensitivity to temperature variation, a simple structure for capacitance detection and no-necessity for extra specific devices for detection, unlike other types of detecting methods. In addition, the gyroscope of the present invention improved its non-linearity by adoption of difference detecting type.

FIG. 6 is a circuit diagram showing one embodiment of the present invention using a gyroscope capacitor.

The comb electrode is connected with the negative input terminal of the OP amp, and the two sensor electrodes 7,8 are connected with the pulse voltage generator so that sine waves are applied with a 180° phase difference from each other. The positive input terminal of the OP amp is grounded and a capacitor (Cᵢₙₜ) is connected between the negative input terminal and the output terminal. The circuits form an integrator to show the current variation according to the difference of the capacitance between the comb electrode and the two sensor electrodes 7,8.

Next, the equations for the sensor capacitances and the definition of the variables and the constants are provided.

Table 3 shows the design variables for the capacitance detection of the sensor part.

TABLE 3

| factor | design variable | value |
|---|---|---|
| dielectric constant | ε₀ | 8.85E−12 |
| number of sensor electrodes | Nₛ | 60, 20 |
| interlink length of sensor electrodes | Lₛ | 300, 232 μm |
| gap of sensor electrodes | gₛₒ | 2 μm |
| height of sensor electrodes | h | 10.3 μm |
| sensor capacitance at y = 0 | C₀ | 1.032 pF |
| sensor capacitance in y+ | C₀₊ | |
| sensor capacitance in y− | C₀₋ | |

${C}_{0 +} = {ϵ}_{0} \frac{{hL}_{s}}{{g}_{s0} - y} {N}_{s}$
${C}_{0 -} = {ϵ}_{0} \frac{{hL}_{s}}{{g}_{s0} + y} {N}_{s}$
${C}_{0 +} = {C}_{0 -} = {C}_{0} , y = 0$

The capacitance variation according to the minor displacement can be shown as a differential form.

$$\begin{matrix}{C}_{0 +} - {C}_{0 -} = ϵ \frac{{hL}_{s}}{{g}_{s0} - y} {N}_{s} - {ϵ}_{0} \frac{{hL}_{s}}{{g}_{s0} + y} {N}_{s} \\ ≅ {ϵ}_{0} \frac{{hL}_{s}}{{g}_{s0}} {N}_{s} ( 1 + \frac{y}{{g}_{s0}} ) - {ϵ}_{0} \frac{{hL}_{s}}{{g}_{s0}} {N}_{s} ( 1 - \frac{y}{{g}_{s0}} ) \\ = {ϵ}_{0} \frac{{hL}_{s}}{{g}_{s0}} {N}_{s} \frac{2 y}{{g}_{s0}} \\ = \frac{2 {C}_{0}}{{g}_{s0}} y [ p F ] \\ \frac{\partial }{\partial y} ( {C}_{0 +} - {C}_{0 -} ) = {ϵ}_{0} \frac{{hL}_{s}}{( {g}_{s0} - y )} {N}_{s} + {ϵ}_{0} \frac{{hL}_{s}}{{( {g}_{s0} + y )}^{2}} {N}_{s} \\ ≅ \frac{2 {C}_{0}}{{g}_{s0}}\end{matrix}$$

Linear capacitance variations with respect to the Y-directional displacement of the outer sensor gimbals can be achieved as shown above.

The sensitivity of the vibratory angular rate sensor according to the present invention primarily depends on the displacement of the outer sensor gimbals that is the comb electrode, and the displacement of the comb electrode becomes larger, if the drive resonance displacement becomes larger. In the embodiment of the present invention, it is designed to be above 40 μm, which is higher than roughly 10 times than that of the conventional MEMS process. The sensitivity of the angular rate sensor of the present invention is improved.

Along with the drive part resonant displacement, another important factor to be considered is a response quality for the drive frequency of the sensor part, which is very difficult to design because it has a very significant effect on the bandwidth as well as the sensitivity of the angular rate. The angular rate sensor according to the present invention is a four-order system composed of the combination of two two-order systems, being the drive system and the sensor system. Therefore, two resonance maximum points are shown for the frequency response and the angular rate sensor is driven between the two resonance frequencies thereby detecting the response of the sensor part according to the outer applied angular rate.

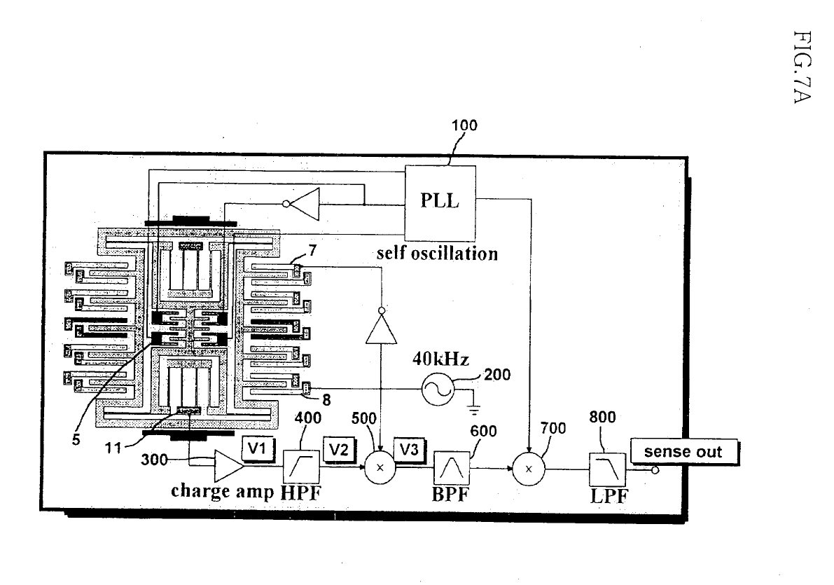

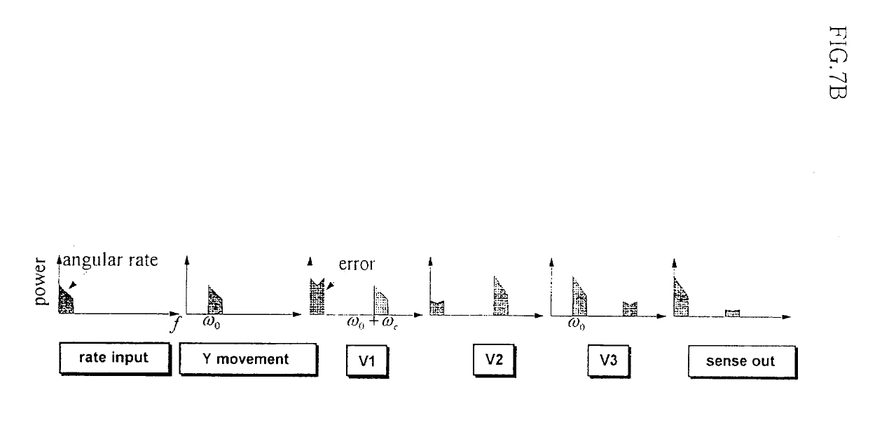

FIG. 7a is a circuit diagram showing the angular rate measurement process according to one embodiment of the present invention, and FIG. 7b shows graphical representations of output processes of angular rates through the circuits of FIG. 7a.

As shown in FIG. 7a, a drive circuit 100 is connected to the drive electrode 5 of the micromachined gyroscope, and a 40 kHz sine wave power source 200 is connected to the sensor electrodes 7,8. The voltages applied on the sensor electrodes 7,8 are sine waves having a 180° phase difference. A sense wire is connected to the fixed anchor 11, and the sense wire is disposed such that sensor signals are output through an amplifier 300, a high-pass filter (HPF) 400, a first demodulator 500, a band-pass filter (BPF) 600, a second demodulator 700 and a low-pass filter 800.

The micromachined gyroscope is driven by the application of a 400 mV sine wave at 4V DC at a frequency of 2.294 kHz.

The sensor part comprises a charge amplifier using a difference detector of carrier charges, and it detects the capacitance variation voltage by changing the capacitance variation to current variation and integrating it.

The above method provides good quality with respect to inner and outer noise, and no drift voltage occurs inside the micromachined gyroscope.

The carrier frequency for capacitance detection of the micromachined gyroscope is 40 kHz, and the modulated angular rate signal, as shown in FIG. 7b, is detected with an original angular rate signal through the demodulation of carrier signals and drive signals, filtering and phase transition.

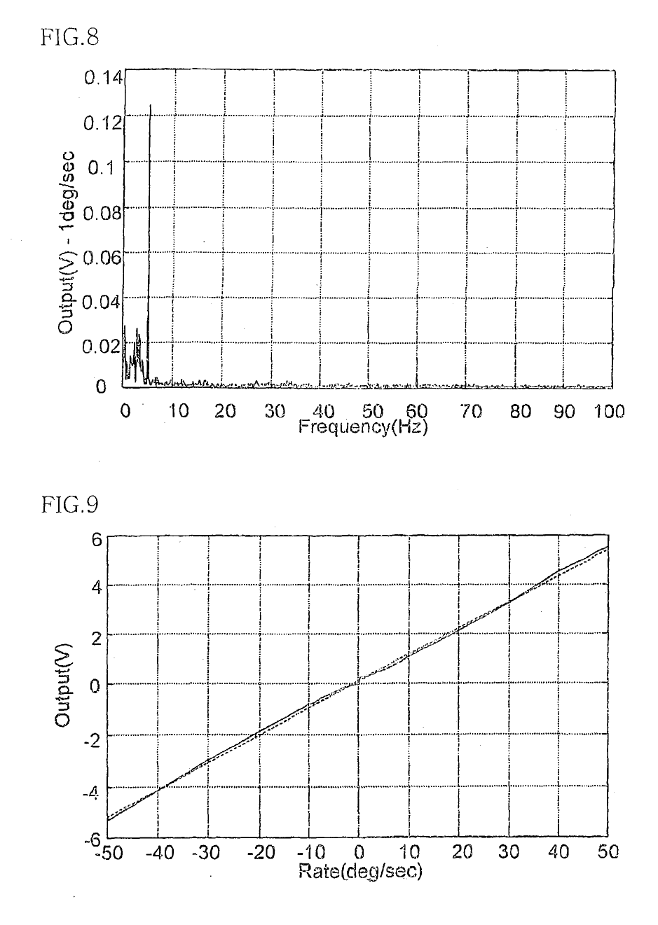

The gyroscope circuit is installed inside the vacuum chamber located on a precision control rate table for angular rate apply test. The vacuum inside the chamber is maintained at 5 mTorr in order to prevent 0 variation in the vacuum environment, and the static and dynamic characteristics according to the applied angular rate are shown in FIGS. 8 and 9.

FIG. 8 shows output waveforms of the gyroscope according to one embodiment of the present invention. FIG. 8 shows output waves when the angular rate signal is applied at 1 deg/sec and 5 Hz sine wave, and the noise equivalent density is 0.002 deg/sec/√Hz

FIG. 9 is a waveform of applied angular rates to detected voltage according to the present invention, showing the output voltage in the case of applying an angular rate signal with a range of ±50 deg/sec. The experimental test was performed up to ±150 deg/sec and the output linearity showed a 0.5744% error.

The micromachined gyroscope according to the present invention is manufactured by determination of the resonance frequency affecting the response performance of the micromachined gyroscope, and gimbals structure for removing interference and noise as described above, and its performance data is shown below, in Table 4.

TABLE 4

| Technical Data | Performance | |
|---|---|---|
| equivalent noise rate [σ] | 0.007 | deg/sec |
| equivalent noise density | 0.002 | deg/sec/√Hz |
| dynamic range | ±150 | deg/sec |
| sensitivity | 114.7 | mV/deg/sec |
| linearity | <0.5744% | FSO |

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

As described above, a gimbals structure angular rate sensor operated by static electricity driving and capacitance variation detection is provided thereby maximizing the performance of the angular rate sensor with both electrical and mechanical responses combined.

What is claimed is:

1. A vibratory micromachined gyroscope comprising:
an inner drive gimbals of a planar gimbals structure; and
an outer sensor gimbals of a planar gimbals structure,
wherein the vibratory micromachined gyroscope is operated by way of an electrostatic drive and a capacitance variation sensor.

2. The vibratory micromachined gyroscope according to claim 1, wherein the vibratory micromachined gyroscope has a folded flexure structure.

3. A vibratory micromachined gyroscope comprising:
a drive gimbals for vibrating a whole gimbals structure in a first direction;
a sensor gimbals moving in a second direction perpendicular to the first direction when an angular rate is applied;
a driven mode flexure connecting the drive gimbals with a fixed anchor and moving in the first direction; and
a sensor mode flexure connecting the drive gimbals and the sensor gimbals and moving in the second direction.

4. The vibratory micromachined gyroscope according to claim 3, further comprising a sensor electrode designed such that a capacitance between the sensor electrode and the sensor gimbals varies according to the displacement of the sensor gimbals in the second direction.

5. The vibratory micromachined gyroscope according to claim 4, wherein the sensor electrode comprises a first sensor electrode and a second sensor electrode, and when a first capacitance between the first sensor electrode and the sensor gimbals increases, a second capacitance between the second sensor electrode and the sensor gimbals decreases, and conversely, when the first capacitance decreases, the second capacitance increases.

6. The vibratory micromachined gyroscope according to claim 5, wherein the first sensor electrode and the second sensor electrode are placed on each side of a sensor comb part that is a part of the sensor gimbals.

7. The vibratory micromachined gyroscope according to claim 5, further comprising an integrator for outputting a current variation according to a difference between the first capacitance and the second capacitance in the form of a voltage.

8. The vibratory micromachined gyroscope according to claim 3, further comprising a drive electrode for causing the vibration of the whole gimbals structure in the first direction.

9. The vibratory micromachined gyroscope according to claim 8, wherein the drive electrode is designed to intermesh with a drive comb part that is a part of the drive gimbals.

10. The vibratory micromachined gyroscope according to claim 3, further comprising a tuning electrode for controlling a displacement variation of the sensor gimbals in the second direction according to the angular rate.

11. The vibratory micromachined gyroscope according to claim 10, wherein the tuning electrode comprises a first and a second tuning electrode, and the first tuning electrode and the second tuning electrode are placed on each side of a sensor comb part that is a part of the sensor gimbals.

12. The vibratory micromachined gyroscope according to claim 3, further comprising a rebalancing electrode for constraining a vibration of the sensor gimbals in the second direction.

13. The vibratory micromachined gyroscope according to claim 3, further comprising a buffer directly connected with the drive gimbals through the driven mode flexure and directly connected with the fixed anchor through another driven mode flexure.
